(19) United States
(12) Patent Application Publication
(10) Pub. No.: US 2015/0333609 A1
(43) Pub. Date: Nov. 19, 2015

(54) OSCILLATING MOTOR FOR A PERSONAL CARE APPLIANCE

(71) Applicant: L'Oreal, Paris (FR)

(72) Inventors: Elisabeth Kathryn Lattanzi, Fairfax, VA (US); Joseph Eric Skidmore, Issaquah, WA (US); Suk Ping Wong, Sammamish, WA (US)

(73) Assignee: L'Oreal, Paris (FR)

(21) Appl. No.: 14/279,203

(22) Filed: May 15, 2014

(51) Int. Cl. H02K 33/16; A46B 13/02

(52) U.S. Cl. CPC H02K 33/16; A46B 13/026

(57) ABSTRACT

Disclosed are oscillating systems and/or apparatus for generating motive force or torque. The oscillating systems and/or apparatus described herein are capable of providing suitable oscillating motion to a workpiece of, for example, a personal care appliance.

### BACKGROUND

Personal care appliances typically use a motor to produce a particular workpiece movement/action, which in turn produces desired functional results. Examples of such appliances include power skin brushes, power toothbrushes and shavers, among others.

In some currently available personal care appliances, the motor arrangement produces an oscillating (back and forth) action rather than a purely rotational movement. Several known oscillating motors are disclosed in U.S. Pat. No. 7,786,626, or commercially available in Clarisonic® branded products, such as the Aria or the Mia personal skincare product (sometimes referred to herein as the “prior art motor configurations”).

While such oscillating motors are suitable for proving oscillatory motion to many workpieces for achieving desirable results, improvements to such designs are desirable to the industry.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a motor for a personal care appliance is provided. In one embodiment, the motor includes:

a stator driven by a source of alternating current; and

an armature mounted for oscillating movement about an axis, wherein the armature includes a back iron having first and second spaced magnets each having a face, the first and second magnets mounted thereon with the magnetic poles thereof aligned in opposing directions, wherein the armature is mounted such that the armature in operation moves in an arcuate path about the axis;

wherein the distance between the centers of the magnets is up to about 2.35 times the width of the faces of the magnets.

In another aspect, a personal care appliance is provided. In one embodiment, the personal care appliance includes:

an appliance housing;

a workpiece;

a source of alternating current located in the appliance housing;

a motor including

an electromagnet coupled to the source of alternating current;

an armature that moves about an axis in response to receipt of alternating current by the electromagnet, wherein the armature includes a back iron having two spaced magnets mounted thereon with the magnetic poles thereof aligned in opposing directions, wherein the distance between the centers of the magnets is up to 2.35 times the width of the faces of the magnets;

a mounting member affixed to the housing;

a flexure assembly connected between the armature and the mounting member such that the armature moves in an arcuate path about the axis; and

a workpiece mount coupled to and extending from the armature, the workpiece mounted on a free end of the workpiece mount, wherein the workpiece mount is configured such that the workpiece oscillates generally about the axis a desired angle.

In another aspect, a motor for a personal care appliance is provided. In one embodiment, the motor includes:

an electromagnet having a ferromagnetic-core configured to be coupled to a source of alternating current; and

an armature mounted for movement about an axis, wherein the armature includes a back iron having two spaced magnets mounted thereon with the magnetic poles thereof aligned in opposing directions, wherein the armature is mounted such that the armature in operation moves in an arcuate path about the axis;

wherein the distance between the centers of the magnets is 1.95-2.15 times the width of the faces of the magnets.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a partial rear view of a personal care appliance incorporating one example of an oscillating motor in accordance with aspects of the present disclosure;

FIG. 2 is a bottom view of the oscillating motor of FIG. 1;

FIG. 3 is a top isometric view of the oscillating motor of FIG. 2;

FIG. 4A is a schematic representation of one example of a back iron of an armature of the oscillating motor of FIG. 3;

FIG. 4B is a schematic view of another example of a back iron of an armature in accordance with aspects of the present disclosure.

FIG. 5 is another example of an oscillating motor formed in accordance with aspects of the present disclosure;

FIG. 6 is an isometric view of one example of a personal care appliance which may incorporate the oscillating motor of either FIG. 1 or FIG. 5; and

FIG. 7 is a functional block diagram of several components of the personal care appliance of FIG. 6;

FIG. 8 is a graph depicting duty cycle vs. amplitude (in degrees) of a conventional oscillating motor as compared to an oscillating motor in accordance with aspects of the present disclosure;

FIG. 9 is a graph depicting the results of a study comparing increased travel amount vs. magnet movement.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

The following discussion provides examples of oscillating systems and/or apparatus for generating motive force or torque. The examples of the oscillating systems and/or apparatus described herein are capable of providing suitable oscillating motion to a workpiece of, for example, a personal care appliance. In these examples and others, the workpiece of the personal care appliance may include but is not limited to cleansing brushes, exfoliating brushes, exfoliating discs, toothbrushes, shaving heads, etc. In some examples described herein, the oscillating system is in the form of an oscillating motor that produces improved oscillation amplitude from a supply current similar to that of the prior art device of U.S. Pat. No. 7,786,626. In other examples described herein, the oscillating motor can provide the same oscillation amplitude as the prior art device of U.S. Pat. No. 7,786,626 but with substantially reduced supply current. In further examples, the oscillating motor provides lower magnetic (DC) emissions and lower electromagnetic (AC) emissions.

Magnetic (DC) emissions are viewed by some as a potential health concern, particularly for users with particular implantable devices that are magnetically activated (e.g. pacemakers, stents, etc.). Therefore, reduced magnetic flux on the skin is desirable. Similarly, lower electromagnetic (AC) emissions from the system are desirable. Extra low frequency (ELF) restrictions are now in place in certain areas for certain device types. In the present embodiments, with better magnetic coupling, the potentially harmful electromagnetic fields are reduced.

For example, the ELF from an exemplary device showed a 20% reduction in electromagnetic emission levels (compared to a previous Clarisonic® brush device) when the magnet location was optimized in accordance with the disclosed embodiments. The ELF was measured with an isotropic antenna and an EMF meter.

In many of the examples set forth herein, the oscillating action generated by the oscillating motor may be rotational, translational, or a combination thereof.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

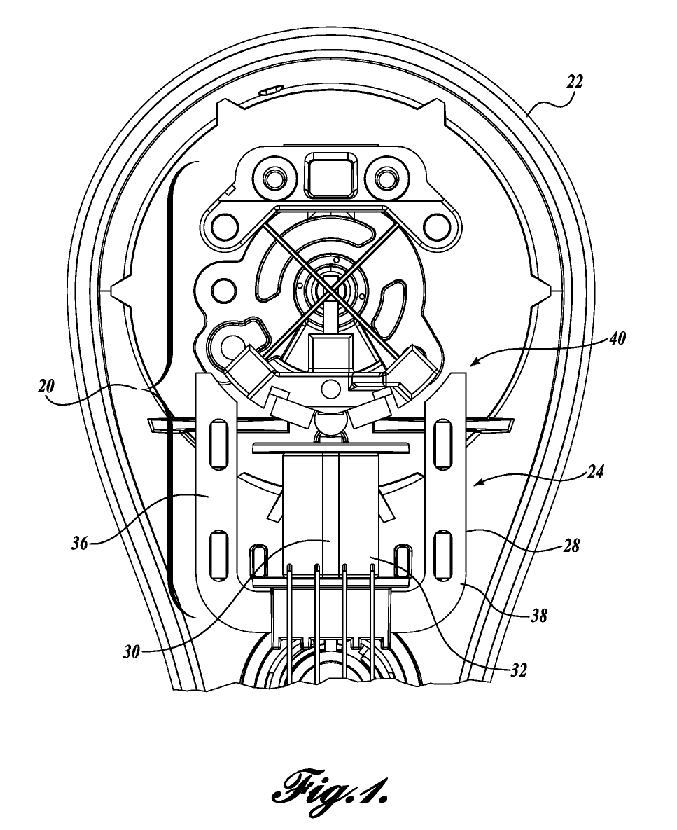

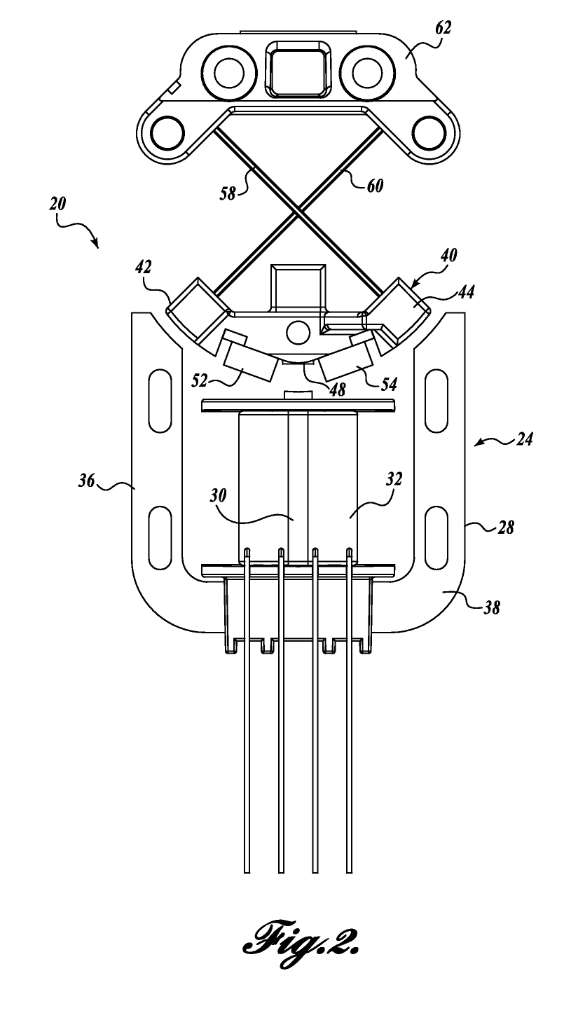

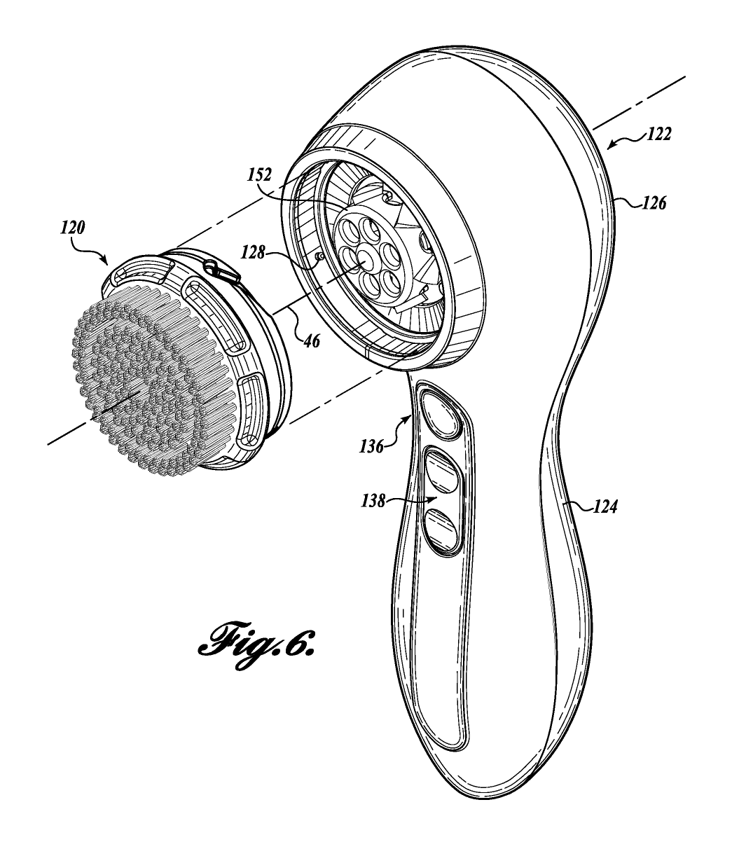

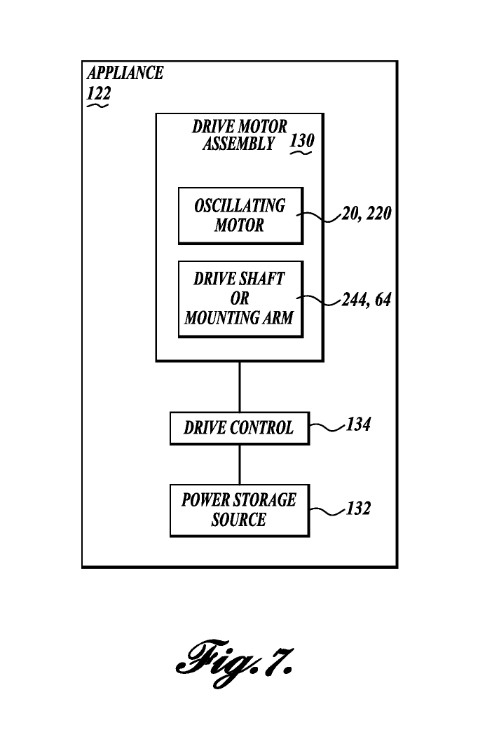

Turning now to FIG. 1, there is shown a partial rear plan view of one example of an oscillation motor, generally designated 20, formed in accordance with aspects of the present disclosure. FIG. 2 is a bottom view of the oscillating motor of FIG. 1. The oscillating motor 20 is suitable for use with a personal care appliance, such as appliance 122, illustrated in FIGS. 6 and 7, for providing oscillating motive force or torque to a workpiece, such as for example, a cleansing brush, an exfoliating brush, an exfoliating disc, a toothbrush, etc. As shown in FIGS. 1 and 2, the oscillating motor 20 includes a stator 24, sometimes referred to as an electromagnet or field magnet. In the embodiment shown, the stator 24 includes an E-core 28 having a center leg 30 upon which a stator coil 32 is wound and two outer legs 36 and 38. In some embodiments, the coil has from 100 to 150 windings or greater, drastically improving the efficiency (up to 29%) of the motor 20 over the prior art configurations. The coil 32 is connected to a source of alternating current, as will be described in more detail below. In operation, the coil 32 generates a magnetic field of reversing polarity when alternating current is passed through the coil 32 and around center leg 30.

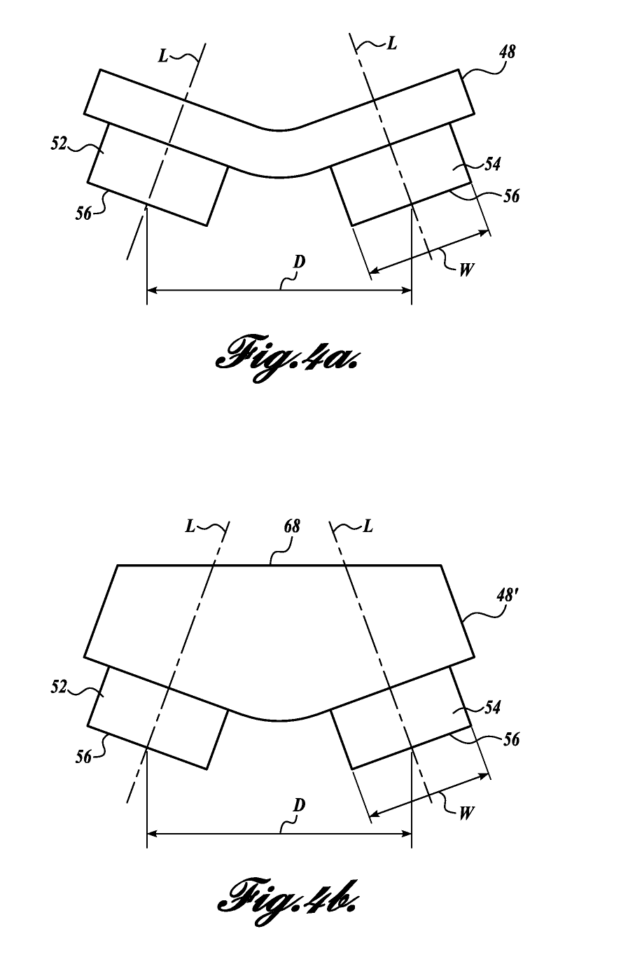

Referring to FIGS. 1-3, the oscillating motor 20 also includes an armature 40 mounted for movement about an axis 46. The armature 40 of the motor 20 has a somewhat curved configuration, including tip ends 42 and 44, as shown in FIG. 2. The tip ends 42 and 44 are positioned to be closely adjacent the curved free ends of outer legs 36 and 38 of the stator E-core 28 in a stationary position. As shown in FIGS. 2 and 4A, the armature 40 includes a back iron member 48, which is made from a ferromagnetic material. Two or more spaced magnets 52 and 54 are mounted on the back iron 48, with magnetization in the radial direction. The magnets 52 and 54 are arranged such that the north pole of one magnet 52 faces outwardly while the north pole of the other magnet 54 faces inwardly. It should be understood, however, that the orientation could be reversed as long as the magnet poles point in opposite directions.

In some embodiments, the back iron 48 includes two surfaces disposed at an angle to one another onto which the two or more magnets 52 and 54 are mounted. Examples of magnets 52 and 54 that can be practiced with embodiments of the present disclosure are set forth in or employed by the prior art motor configurations. As assembled, the position and orientation of the magnets 52 and 54 are such that a line L normal to the face 56 of the magnets, passing through the midpoint of the magnet face, also passes through the axis 46. As will be described in more detail below, the distance D between the centers of the faces of magnets 52 and 54 affects motor efficiency.

In some of embodiments of the present disclosure, the oscillating motor can have one or more of the following characteristics, in any combination: the width of the E-core center leg 30 can be from about 0.50 to 0.60 times the width of the face of the magnets, and 0.56 in some embodiments; the width of the outer legs 36 and 38 can be from about 0.90 to 1.10 times the width of the face of the magnets, and 1.02 times in some embodiments; the width of the distances between center leg 30 and outer legs 36 and 38, respectively, can be from 1.95 to 2.20 times the width of the face of the magnets, and 2.07 in some embodiments; the length of center leg 30 can be from 1.95 to 2.15 times the width of the distance between the center leg 30 and one of the outer legs 36, 38, and 2.06 in some embodiments.

The oscillating motor 20 also includes a mounting element 62 which is secured to the housing 126 of the appliance 122 (See FIG. 6), thus becoming a mechanical reference for the oscillating system. The armature 40 is coupled to the mounting element 62 by a pair of fixture elements, shown as flexure elements 58 and 60 in this embodiment, although additional flexure elements can be used. In one example, the flexure elements are made from spring steel material, and are approximately 0.025 inch thick. Each flexure element is approximately 0.50 inch high. Flexure elements 58 and 60 are oriented approximately perpendicular to each other and overlap at axis 46, which is the functional pivot point about which armature 40 oscillates.

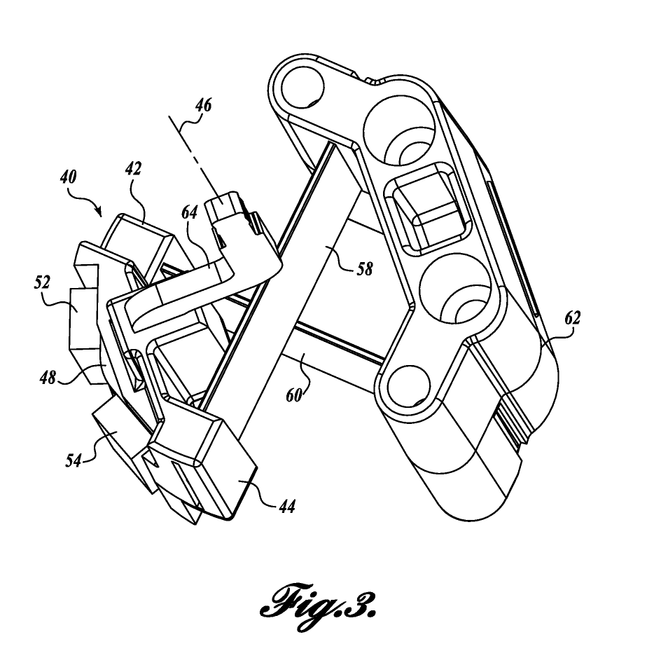

Extending from the armature 40 is the mounting arm 64. As can be seen most clearly in FIG. 3, the mounting arm 64 extends outwardly from the armature 40 and then extends horizontally (parallel with the handle of the appliance) until it reaches the axis, where the mounting arm extends outwardly again approximately at a right angle to the handle. Mounted on the free end of mounting arm 64 is a workpiece, such as a skin brush, etc. The configuration of the mounting arm 64 is thus such that the brush oscillates about axis 46 which extends at a right angle to the handle of the personal care appliance. The location/orientation of the mounting arm can be changed, for instance by moving the location of the tip away from axis 46, to produce a combined rotational/translational movement of the workpiece.

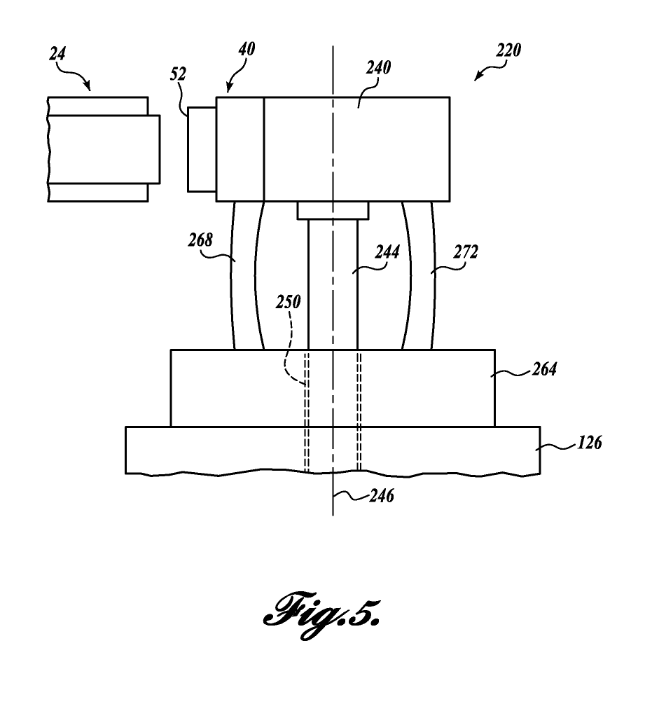

Turning now to FIGS. 6 and 7, there is shown one example of the personal care appliance 122. The appliance 122 includes a body 124 having a handle portion 126 and a workpiece attachment portion 128. The workpiece attachment portion 128 is configured to selective attach a workpiece 120 to the appliance 122. The appliance body 124 houses the operating structure of the appliance. As shown in block diagrammatic form in FIG. 7, the operating structure in one embodiment includes a drive motor assembly 130, a power storage source 132, such as a rechargeable battery, and a drive control 134, including an on/off button 136 (See FIG. 6), configured and arranged to selectively deliver alternating current at a selected duty cycle from the power storage source 132 to the drive motor assembly 130. In some embodiments, the drive control 134 may also include a power adjust or mode control buttons 138 (See FIG. 6) coupled to control circuitry, such as a programmed microcontroller or processor, which is configured to control the delivery of alternating current to the drive motor assembly 130. The drive motor assembly 130 includes an oscillating motor, such as motor 20 or 220 (See FIG. 5), which drives an attached workpiece via a drive shaft 244 (See FIG. 5) or mounting arm 64 (See FIG. 3).

In operation, an alternating current is supplied to the stator coil 32 from the power storage source 132 under control of drive control 134, resulting in an arcuate movement of the armature 40 about axis 46, due to the attractive/repulsive action between the three legs 30, 36, and 38 of the stator E-coil 28 and permanent magnets 52 and 54 on the back iron 48. The particular arrangement of the stator E-coil 28 and the armature 40 results in a substantially rotational oscillation of a selected angle about the axis 46. In some embodiments, the instantaneous center of rotation may move in a very small (approximately 0.010 inches) complex curve offset about the shaft center point when it is at rest. The angular range of oscillation can be varied, depending upon the configuration of the armature and the stator and the characteristics of the alternating drive current. In some embodiments, the motion in one of various settings (e.g., low, normal, high, pro, etc.) is within the range of 3 to 21 degrees about the pivot axis.

In accordance with aspects of the present disclosure, the distance D (See FIG. 4A) between the centers of the faces of magnets 52 and 54 has been determined by the inventors of the present disclosure to affect the efficiency of the motor 20. In that regard, through simulations and empirical studies, the inventors found that the distance D of less than 2.40 times the width of the face of the magnets achieves improved results over the oscillating motors of the prior art configurations. In embodiments of the present disclosure, the distance D can be one of the following: up to but not including 2.40 times the width W of the face of the magnets; up to 2.35 times the width of the face of the magnets, up to 2.30 times the width of the face of the magnets, up to 2.25 times the width of the face of the magnets; up to 2.15 times the width of the face of the magnets; and between about 1.80 and 2.15 times the width of the face of the magnets. In one embodiment, the distance D is between 2.05 and 2.09 times the width of the face of the magnets, and in another embodiment, the distance is 2.07 times the width of the magnet face.

Oscillating motors with such magnet distances provide improved efficiency over prior art configurations. In that regard, efficiency was shown in simulations to have improved approximately 26% over the prior art configurations. Such improvement was also shown in an empirical study to be between 20 and 40%. In this experiment, the only difference between the configuration of the motor 20 and the prior art configuration was that the distance D of motor 20 was 0.413″ or 2.07 times the width of the face of the magnets. The results of this test are shown in Table 1 below.

| | | | | | Battery | Battery | |
|---|---|---|---|---|---|---|---|
| | | Duty | Duty | Percentage | Draw | Draw | |
| | Amplitude | Cycle | Cycle | Reduction | Optimized | Existing | Percentage |
| Handle | in | Optimized | Existing | (Duty | Motors | Motors | Reduction |
| Setting | Degrees | Motors | Motors | Cycle) | (mA) | (mA) | (Battery) |
| Low | 7 | 11.56% | 14% | 18% | 193.67 | 252.10 | 23% |
| Normal | 9 | 14.00% | 18% | 22% | 281.89 | 352.50 | 20% |
| High | 12 | 17.44% | 24% | 27% | 384.00 | 639.00 | 40% |
| Pro | 15 | 22.67% | 29% | 22% | 544.44 | 952.50 | 43% |

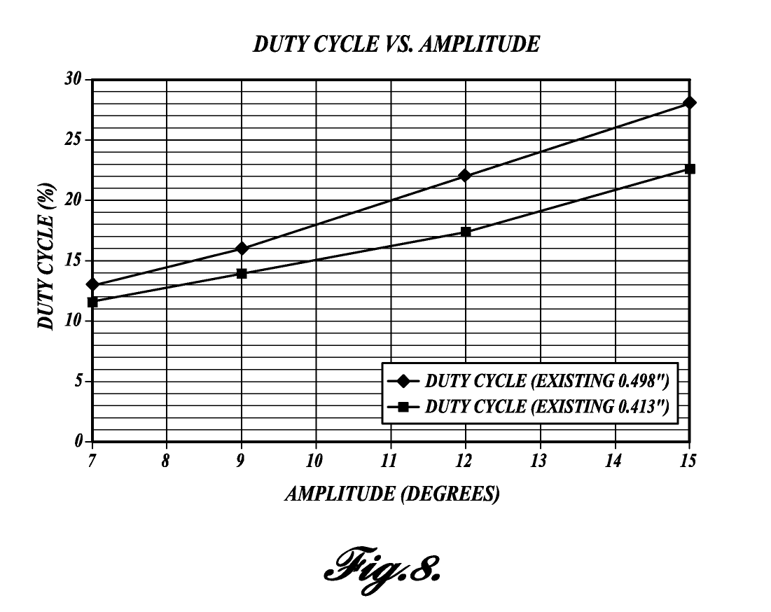

As shown in the test results, motors configured in accordance with aspects of the present disclosure can produce the same torque/amplitude as the prior art motor configurations but with reduced current. A graph depicting the relationship between duty-cycle and amplitude based on the results of this study is shown in FIG. 8.

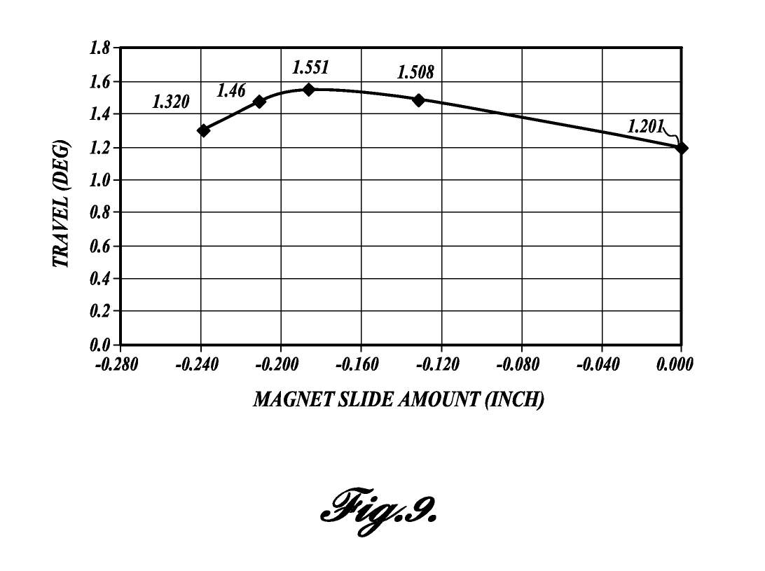

Further, motors configured in accordance with aspects of the present disclosure show improved (increased) amplitude (up to 4 degrees in some embodiments) using the same amount of current as the prior art motor configurations. FIG. 9 is a graph showing the relationship between increased travel in one direction (in degrees) and change in magnet position. In the graph of FIG. 9, 0.000″ represents the magnet spacing of 0.498″ (i.e., 2.49 times the width of the magnet face) of the prior art motor configurations. As such, the value −0.200 in FIG. 9, for example, is equivalent to a spacing distance D of 0.298″ (i.e., 1.49 times the width of the magnet face). Additional variables of this simulation include an operating frequency of 175 Hz and a coil having 150 turns.

FIG. 4B illustrates another example of a back iron 48′ that may be employed by the oscillating motor 20 in accordance with aspects of the present disclosure. The configuration of back iron 48′ was the result of a study of the flux-density maps of the back iron 48 of FIG. 4A in operation. Plotting the flux-density map revealed the areas of highest saturation, which could be addressed to gain efficiency in the motor 20. In order to reduce the flux-density levels at these areas, an improved configuration was developed, one example of which is shown in FIG. 4B. As best shown in FIG. 4B, additional material mass was added in strategic locations to improve the flux-density characteristics of the back iron 48′ when operating as part of motor 20. In that regard, the cross section of the back iron 48′ is generally pentagonal in shape by extending the lateral end surfaces of the back iron 48′ further away from the magnets 52 and 54 along planes generally parallel with lines L. Back surface 68 then extends between the end edges of the lateral surfaces generally horizontal to the longitudinal axis of the center leg 30 when stationary as assembled. The configuration of the back iron 48′ improves the flux flow and magnetic coupling between the magnets.

Simulations conducted on this back iron configuration show that motor efficiency improves up to 7% over the back iron configuration of FIG. 4A. Simulations further showed a synergistic effect in embodiments that employed both the back iron 48′ and improved magnet spacing D as set forth in detail above. In these simulations, an efficiency improvement of up to 40% was obtained.

FIG. 5 is another example of an oscillating motor 220, which may be practiced with various embodiments of the present disclosure. The oscillating motor 220 is substantially similar in construction and operations as the oscillating motor 20 described above with reference to FIGS. 1-4B except for the differences that will now be described. The oscillating motor 220 includes the stator 24 and the functionality of the armature 40 of motor 20 described above but with a differently configured fixture arrangement. In that regard, attention is directed to FIG. 5 where there is shown the armature 40 coupled to or integrally formed with an armature plate 240. Affixed to the forward facing side of the armature plate 240 for co-rotation is a drive shaft 244 that projects orthogonal to the armature plate 240 and extends through a bearing 250 in a mounting element 264. In the embodiment shown, the bearing 250 is in the form of a through bore, which defines the rotational axis of the armature 40.

The mounting element 264 is secured to the housing 126 of the personal care appliance, thus becoming the mechanical reference for the oscillating system. Mounted to the free end of the drive shaft 244 is the workpiece, such as the skin brush. The armature 40 is coupled to the mounting element 264 by a plurality of spaced fixture elements, shown in this embodiment as three flexure elements 268, 272 and 274 (hidden in FIG. 5) that extends generally parallel to the drive shaft. Additional flexure elements can be used. Through the armature plate 240, the drive shaft 244, the mounting element 264 and the fixture arrangement, the armature 40 is mounted for movement about the axis 246 defined by the bearing 250.

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A motor for a personal care appliance, comprising:
a stator driven by a source of alternating current; and
an armature mounted for oscillating movement about an axis, wherein the armature includes a back iron having first and second spaced magnets each having a face, the first and second magnets mounted thereon with the magnetic poles thereof aligned in opposing directions, wherein the armature is mounted such that the armature in operation moves in an arcuate path about the axis;
wherein the distance between the centers of the magnets is up to about 2.35 times the width of the faces of the magnets.

2. The motor of claim 1, wherein the magnets are mounted at an angle to one another.

3. The motor of claim 1, wherein the stator includes a field magnet having a coil with between 100 and 150 windings.

4. The motor of claim 1, wherein the stator includes a field magnet having a coil with between 120 and 150 windings.

5. The motor of claim 1, further comprising a mounting member affixed to a housing portion of the personal care appliance and a fixture arrangement interconnecting the armature and the mounting member.

6. The motor of claim 5, wherein the mounting member or the fixture arrangement defines the axis.

7. The motor of claim 5, wherein the fixture arrangement includes a flexure assembly including at least two separate flexure members which cross each other between the mounting member and the armature, wherein the axis is coextensive with the line formed by the crossed flexure members.

8. The motor of claim 7, wherein the armature includes a mounting arm configured to couple to a workpiece, the mounting arm configured to move about a pivot axis approximately where the flexure members cross.

9. The motor of claim 5, further comprising a drive shaft configured to couple to a workpiece and coupled for co-rotation with the armature, wherein the fixture arrangement includes a flexure assembly including at least two separate flexure members that extend between the armature and the mounting member generally parallel with the drive shaft.

10. The motor of claim 1, wherein the back iron has a generally pentagonal cross-section.

11. The motor of claim 1, wherein the back iron is configured to evenly distribute flux density when magnetically coupled to the stator.

12. The motor of claim 1, wherein the back iron includes means for reducing saturation when magnetically coupled to the stator.

13. A personal care appliance, comprising:
an appliance housing;
a workpiece;
a source of alternating current located in the appliance housing;
a motor including:
an electromagnet coupled to the source of alternating current;
an armature that moves about an axis in response to receipt of alternating current by the electromagnet, wherein the armature includes a back iron having two spaced magnets mounted thereon with the magnetic poles thereof aligned in opposing directions, wherein the distance between the centers of the magnets is up to 2.35 times the width of the faces of the magnets;
a mounting member affixed to the housing;
a flexure assembly connected between the armature and the mounting member such that the armature moves in an arcuate path about the axis; and
a workpiece mount coupled to and extending from the armature, the workpiece mounted on a free end of the workpiece mount, wherein the workpiece mount is configured such that the workpiece oscillates generally about the axis a desired angle.

14. The personal care appliance of claim 13, wherein the desired angle has a maximum of about 21 degrees.

15. The personal care appliance of claim 13, wherein the workpiece mount is one or a mounting arm and a driveshaft.

16. The personal care appliance of claim 13, wherein the electromagnet includes a coil having one of the following ranges of turns: between 110 and 150; between 120 and 150; between 130 and 150; and between 140 and 150.

17. The personal care appliance of claim 13, wherein the back iron includes means for reducing flux density levels in the back iron when magnetically coupled to the electromagnet.

18. A motor for a personal care appliance, comprising:
an electromagnet having a ferromagnetic-core configured to be coupled to a source of alternating current;
an armature mounted for movement about an axis, wherein the armature includes a back iron having two spaced magnets mounted thereon with the magnetic poles thereof aligned in opposing directions, wherein the armature is mounted such that the armature in operation moves in an arcuate path about the axis; and
wherein the distance between the centers of the magnets is 1.95-2.15 times the width of the faces of the magnets.

19. The motor of claim 18, wherein the back iron includes means for reducing saturation when magnetically coupled to the electromagnet.

20. The motor of claim 19, wherein the electromagnet includes a coil having one of the following ranges of turns: between 110 and 150; between 120 and 150; between 130 and 150; and between 140 and 150.
